(19) United States
(12) Patent Application Publication
(10) Pub. No.: US 2018/0012165 A1
(43) Pub. Date: Jan. 11, 2018

(54) SYSTEMS AND METHODS FOR EVENT PARTICIPANT PROFILE MATCHING

(71) Applicant: RACHEL WEINSTEIN PODOLSKY, LOS ANGELES, CA (US)

(72) Inventor: RACHEL WEINSTEIN PODOLSKY, LOS ANGELES, CA (US)

(21) Appl. No.: 15/641,440

(22) Filed: Jul. 5, 2017

Related U.S. Application Data
(60) Provisional application No. 62/358,229, filed on Jul. 5, 2016.

(51) Int. Cl. G06Q 10/06; G06Q 50/00

(52) U.S. Cl. CPC G06Q 10/06313; G06Q 50/01

(57) ABSTRACT

Disclosed are various embodiments for optimizing social and/or business events organized to facilitate face-to-face interactions among participants to allow the participants to become better acquainted. An organizer of the event can submit event parameters. During each round of the event, event round matches between participants are determined according to at least the event parameters and participant profile information. Notifications can be sent to each participant to notify each participant of their seating location and match for each event round. Participants can be notified of a level of interest for different participants.

### CROSS REFERENCE TO RELATED APPLICATION

This application claims priority to co-pending U.S. provisional application entitled, “Systems and Methods for Event Participant Profile Matching,” having application No. 62/358,229, filed Jul. 5, 2017, which is entirely incorporated herein by reference.

### BACKGROUND

Social and business networking events are organized events that facilitate face-to-face interaction of participants through a series of event rounds in which the participants meet with different participants during each round. Typically, participants are able to provide input regarding their level of interest in other participants with whom they have interacted with during an event round. An event organizer may review the inputs received by the participants and notify the participants when they have a complementary level of interest with one or more of the other participants.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIG. 2 is a pictorial drawing of an example of an event layout to encourage participants to interact during organized rounds of an event according to various embodiments of the present disclosure.

FIGS. 3A-3D are pictorial diagrams of example user interfaces rendered by an organizer client in the networked environment of FIG. 1 according to various embodiments of the present disclosure.

FIGS. 4A and 4B are pictorial diagrams of example user interfaces rendered by a participant client in the networked environment of FIG. 1 according to various embodiments of the present disclosure.

FIG. 5 is a flowchart illustrating one example of functionality implemented as portions of a participant matching application executed in a computing environment in the networked environment of FIG. 1 according to various embodiments of the present disclosure.

FIG. 6 is a flowchart illustrating one example of functionality implemented as portions of a feedback notification application executed in a computing environment in the networked environment of FIG. 1 according to various embodiments of the present disclosure.

FIG. 7 is a schematic block diagram that provides one example illustration of a computing environment employed in the networked environment of FIG. 1 according to various embodiments of the present disclosure.

### DETAILED DESCRIPTION

The present disclosure relates to systems and methods associated with social and/or business events organized to facilitate face-to-face interactions among participants to allow the participants to become better acquainted. The events may comprise dating events, networking events, and/or other types of events where the event may comprise one or more rounds in which the participants are matched in pairs and/or groups based in part on participant profile information and/or the venue layout. The system of the present disclosure can be employed to (1) provide navigation for each participant during the event (e.g., table and/or seat location for each round, information about a matched participant for a round, etc.), (2) facilitate an automated data entry of results, participant feedback analysis, participant event round matching, and results notification, and (3) customize matching of participants according to participant preferences (e.g., age, gender, interests, occupation, etc.).

According to various embodiments, the system of the present disclosure includes two primary interfaces. The event organizer interface allows an event organizer to register participants as they arrive at the event, set the length of the event rounds, set the number of event rounds, initiate the start of the event, control when and/or how results are sent to each participant, and so on. The participant interface allows the participant to input profile information (e.g., age, gender preference, interests, occupation, etc.); receive messages (e.g., a text message, email, etc.) via a participant client device notifying a participant of a match and/or seating location for each event round; receive feedback forms allowing each participant to provide a level of interest (e.g., rating, like, dislike, etc.) in the other participants paired with the participant during each event round and/or a level of interest in other participants attending the event, but not matched with the participant; receive automated results that indicate any relevant matches and/or other relevant information associated with the event; and so on.

In the following discussion, a general description of the system and its components is provided, followed by a discussion of the operation of the same.

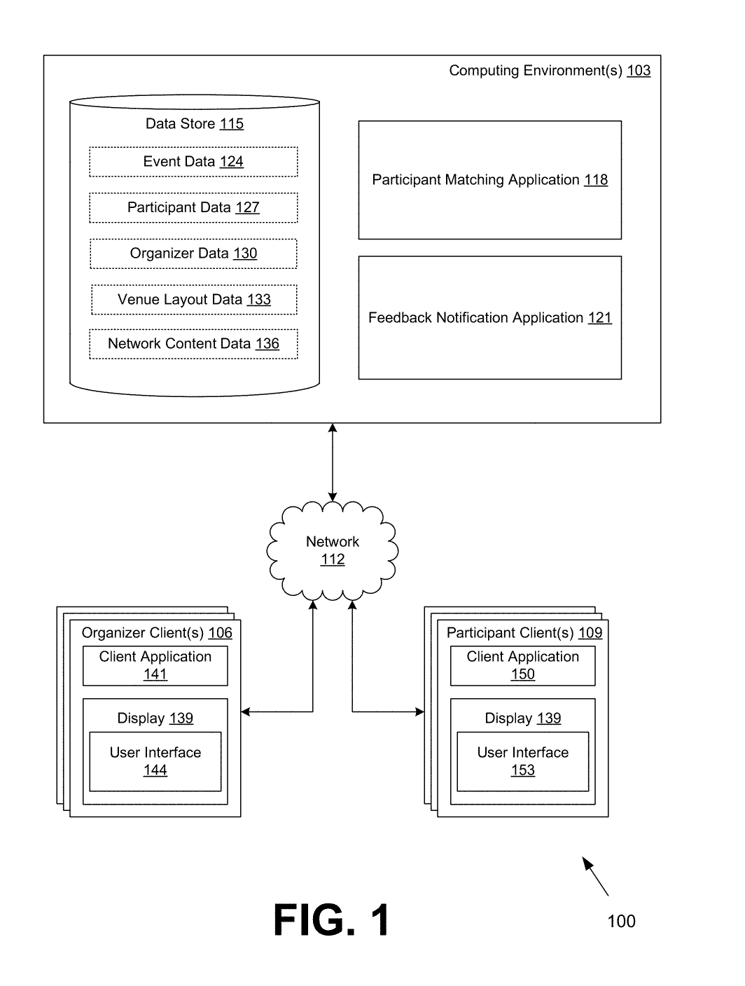

With reference to FIG. 1, shown is a networked environment 100 according to various embodiments. The networked environment 100 includes a computing environment 103, one or more organizer clients 106, and one or more participant clients 109, which are in data communication with each other via a network 112. The network 112 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted or “cloud” computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 115 that is accessible to the computing environment 103. The data store 115 may be representative of a plurality of data stores 115 as can be appreciated. The data stored in the data store 115, for example, is associated with the operation of the various applications and/or functional entities described below.

The components executed on the computing environment 103, for example, include a participant matching application 118, a feedback notification application 121, and other applications, services, processes, systems, engines, or functionality not discussed in detail herein. The participant matching application 118 is executed to optimize participant matches and seating locations for each event round. The participant matching application 118 is further executed to generate and transmit notifications to individual participants informing each participant of his or her respective match and/or seat location for each round. The notification may be in the form of an email message, a text message, a user interface of a participant client application 150 rendered via the participant client device 109, and/or any other type of notification. In various embodiments, the participant matching application 118 may match participants according to matching parameters, such as, for example, a number of event tables, a number of participants, participant preferences, participant updates following each round, location of individual participants during each round, and/or other information that can be used to optimize the participant matches and seating locations for each round.

The feedback notification application 121 is executed to request, receive, analyze, and report feedback from individual participants with respect to one or more other participants who he or she interacted with during each event round. In some embodiments, the feedback notification application 121 requests feedback at the end of each round. In other embodiments, the feedback notification application 121 requests feedback at the end of the event. The feedback request may be in the form of an email message, a text message, a user interface 153 rendered via the participant client device 109, and/or any other type of notification.

The data stored in the data store 115 includes, for example, event data 124, participant data 127, organizer data 130, venue layout data 133, network content data 136, and potentially other data. The event data 124 comprises information about the event such as for example, name of event, type of event, number of participants, starting time, ending time, number of event rounds, time of each round, time in between each round, number of participants who interact with one another during each round (e.g. pair, group of four, etc.) and/or other information. The participant data 127 comprises information about each participant such as, for example, name, age, gender, sexual orientation, preferred age range for participant matching, occupation, interests, contact information (e.g., phone number, email, address, etc.), picture(s), and/or other information. Organizer data 130 may comprise information about the organizer such as, for example, name, phone, email, and/or other information. Venue layout data 133 may comprise information about the event venue such as, for example, number of tables, number of seats per table, proximity of each table to one another, and/or other information.

Network content data 136 may include images, text, code, graphics, audio, video, and/or other data relating to network pages served up by the participant matching application 118, the feedback notification application 121, and/or other application. To this end, network content data 136 may include static network pages or static elements of network pages, for example, in hypertext markup language (HTML), extensible markup language (XML), and/or any other language suitable for creating network pages. Further network content data 136 may include code that generates dynamic network pages when executed or interpreted in the computing environment 103. Such code may be written in any suitable programming language, such as PHP, Perl, Objective C, Java, Ruby, Python, etc. Network content data 136 may also include code configured to be executed or interpreted within a client in order to render a dynamic network page. Such code may be referred to as applets and may be written in any suitable programming language, such as JavaScript, Java, etc.

The organizer client 106 is representative of one or more client devices that may be coupled to the network 112. The organizer client 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The organizer client 106 may include a display 139. The display 139 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The organizer client 106 may be configured to execute various applications, such as an organizer client application 141 and/or other applications. The organizer client application 141 may be executed in an organizer client 106, for example, to access network content served up by the computing environment 103 and/or other servers, thereby rendering a user interface 144 on the display 139. To this end, the organizer client application 141 may comprise, for example, a browser, a dedicated application, etc., and the user interface may comprise a network page, an application screen, etc. The organizer client application 141 may be configured to execute applications beyond the organizer client application 141 such as, for example, email applications, social networking applications, word processors, spreadsheets, and/or other applications. In some embodiments, the organizer client application 141 may comprise a stand-alone application that is configured to communicate with the participant matching application 118 and/or feedback notification application 121 as can be appreciated.

The participant client 109 is representative of a plurality of client devices that may be coupled to the network 112. The participant client 109 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The participant client 109 may include a display 139. The display 139 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The participant client 109 may be configured to execute various applications, such as a participant client application 150 and/or other applications. The participant client application 150 may be executed in a participant client 109, for example, to access network content served up by the computing environment 103 and/or other servers, thereby rendering a user interface 153 on the display 139. To this end, the participant client application 150 may comprise, for example, a browser, a dedicated application, etc., and the user interface 153 may comprise a network page, an application screen, etc. The participant client application 150 may be configured to execute applications beyond the participant client application 150 such as, for example, email applications, social networking applications, word processors, spreadsheets, and/or other applications. In some embodiments, the participant client application 150 may be a stand-alone application configured to interact with the participant matching application 118 and/or feedback notification application 121 as can be appreciated according to the embodiments of the present disclosure.

Next, a general description of the operation of the various components of the networked environment 100 is provided. To begin, an organizer may create a social interaction event (e.g., dating event, networking event, etc.) to facilitate face-to-face interactions between participants of the event. Via the organizer client application 141, the organizer can input event data 124 associated with the particular event. For example, the organizer via a user interface 144 rendered on the organizer client device 106 may input event data 124 such as an event name, an event location, an event start time, a duration of the event, number of participants, participant information, venue layout data 133 (e.g., number of tables, placement of tables, proximity of tables, etc.), a number of event rounds, time of each event round, time between each round, and/or any other data that is relevant to the event.

At the time of the event, participants can register and/or check-in to the event. In some embodiments, the participants can preregister for the event via the participant client application 150, a third-party application, and/or any other type of preregistration forum as can be appreciated. In other embodiments, as participants arrive at the event location, the participants can register with the organizer. The organizer, via the organizer client application 141, can note that a participant is present. In some embodiments, participants can check-in to an event via the participant client application 150. For example, the participant client application 150 may provide an option to check-in to the event, and upon receipt of an input requesting participant check-in, the participant client application 150 may communicate with the participant matching application 118 requesting registration to the event. To verify that the participant is in fact at the event location, the participant client 109 may comprise a location detection device (e.g., global positioning device (GPS), etc.) that can be used to provide location coordinates, and/or other relevant information that can be used to verify the location of the participant client device 109. If a location of the participant client device 109 is within a predefined range of the event location, the participant can be determined as being present.

According to various embodiments, the participant and/or organizer can input participant data 127 to be used by the participant matching application 118 in determining optimal matches for face-to-face interactions during the event. For example, the participant can create a profile via the participant client application 150 that provides information about each participant such as, for example, name, age, gender, sexual orientation, preferred age range for participant matching, occupation, interests, contact information (e.g., phone number, email, address, etc.), picture(s), and/or other information. In some embodiments, the participant can provide the participant information via the participant client application 150 and/or a third-party application. In other embodiments, the organizer can provide the participant information via the organizer client application 141. The participant data 127 can be established prior to the event and/or at the time of registration at the event.

At the time of the event, the participant matching application 118 can analyze the event data 124, participant data 127, venue layout data 133, and/or any other information to optimize participant matches and seating locations. In various embodiments, the participant matching application 118 may match participants according to matching parameters, such as, for example, a number of event tables, a number of participants, participant preferences, participant updates following each round, location of individual participants during each round, very important person (VIP) status, and/or other information that can be used to optimize the participant matches and seating locations for each round. In some embodiments, the participants may be matched in pairs. In other embodiments, the participants may be matched in groups greater than two.

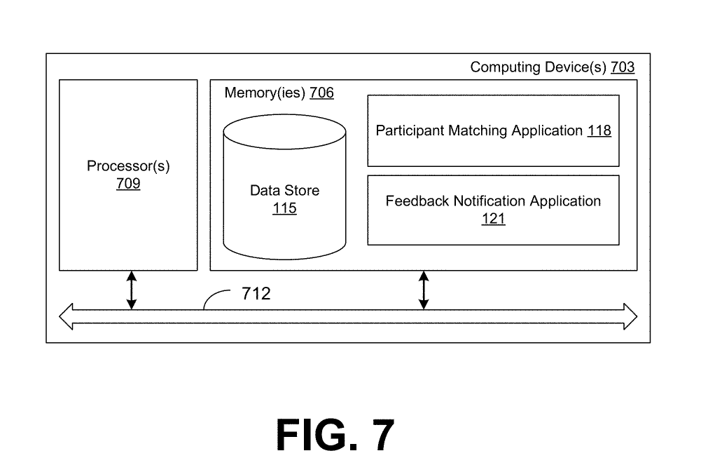

In some embodiments, the participant matching application 118 may generate the participant matches and seating locations via graph theory libraries. In other embodiments, the participant matching application 118 may assign weights to one or more factors and create a score based in part on a sum of the factors. The participants may be ranked according to the score and matched based at least in part on the score. It should be noted that adequate computing resources may need to be appropriated in order to perform the optimization and determination of the participant matches and seating locations for each event round. For example, the processor and memory capabilities of the computing device 703 (FIG. 7) on which the participant matching application 118 is executing need to be such that the participant matching application 118 can analyze the appropriate data to optimize and determine the matches and seating locations during each event round.

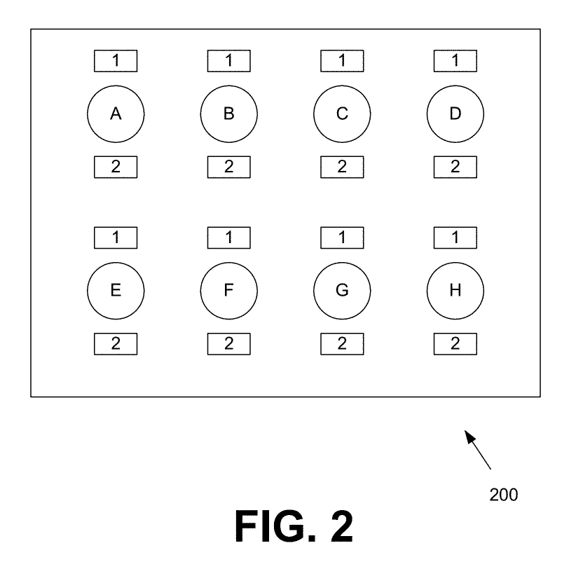

Upon establishing the participant matches, the participant matching application 118 generates and transmits notifications to each participant that include information regarding the participant match and seating location. For example, participant A may receive a notification via a text message that notifies participant A of his or her match with participant B at table F of the event. In some embodiments, the notification may further provide specific seating location for participant A. For example, using the venue layout shown in FIG. 2, which illustrates a pictorial diagram of an example venue layout for an event, the notification may further include information informing participant A to sit at seat “1” at Table F. As previously discussed, the participant client 109 may receive a notification via a text message, an email, a user interface 153 of the participant client application 150 rendered on the client device 109, a user interface associated with a third-party social networking site, and/or any other appropriate type of notification.

Once the participant receives his or her respective notification providing match and/or seating location, each participant proceeds to his or her respective event round position/seat, and the round can begin. During each round, the participants can interact face-to-face to become better acquainted. In some embodiments, the participants may be provided topics, questions, activities and/or other information that can be used to facilitate conversation between the participants. In some embodiments, the participant matching application 118 and/or other application may generate and transmit such conversation topics to the participant client device 109 via a text message, email message, user interface, third-party social networking site and/or other notification as can be appreciated. In some embodiments, the conversation topics may be selected according to shared interests of the participant pair and/or group. In other embodiments, the conversation topics may correspond to a particular event theme. In some embodiments, the round can be started per instruction of the organizer. In other embodiments, the round begins at a predetermined time.

During each event round, the participant matching application 118 analyzes the event data 124, participant data 127, venue layout data 133, and/or other pertinent information to determine a new match. For example, while the participant matching application 118 analyzes participant data 127 to determine an optimal profile match between one or more participants, the participant matching application 118 may also analyze the current seating location of each of the participants and make selections based at least in part on the proximity of participants to one another for a particular round. Using the example venue layout presented in FIG. 2, assume that according to the participant data 127, a participant seated at Table A could be matched with a participant located at Table B and a participant located at Table F. Since Table B is closer to the current location of the participant than Table F, the participant matching application 118 may match the participant with the match at Table B for the next round due to the proximity of the participant to Table A. Upon establishing the new match, the participant matching application 118 can transmit the new notification to each participant notifying him or her of the new match and seating location for the next round.

In some embodiments, the feedback notification application 121 may generate and transmit a feedback form to each participant requesting feedback regarding his or her interests in the participant match from a previous round and/or another participant at the event that the participant has not been matched with. For example, if a participant meets another participant during a break (e.g., restroom, drink table, food table, registration table, etc.), the participant may be able to identify the other participant (e.g., assigned number, name, picture, etc.) and provide feedback (e.g., rating, like/dislike, etc.) via the feedback form. In another non-limiting example, a participant can identify another participant by reviewing pictures and/or profile information displayed on a user interface 153 of the participant client application 150 and rate the other person based at least in part on the other participant's picture and/or profile information. In other embodiments, the feedback notification application 121 may generate and transmit the feedback form to each participant at the end of the event requesting feedback for each of the other participants that were matched during each round of the event and/or other participants at the event that the participant was not matched with.

Upon receipt of the feedback form, the participant can provide feedback via the feedback form regarding his or her interest in each of the matched participants and/or other participants. In some embodiments, the feedback provided on the feedback form can be used as a learning tool for the participant matching application 118 in generating participant matches for future event rounds. For example, a participant may indicate via the feedback form that they do not have interest in one or more participants from prior event rounds that were of a certain age. As such, the participant matching application 118 may be able use this information as a negative factor for future event round matches so that the participant is no longer matched with individuals of the same age.

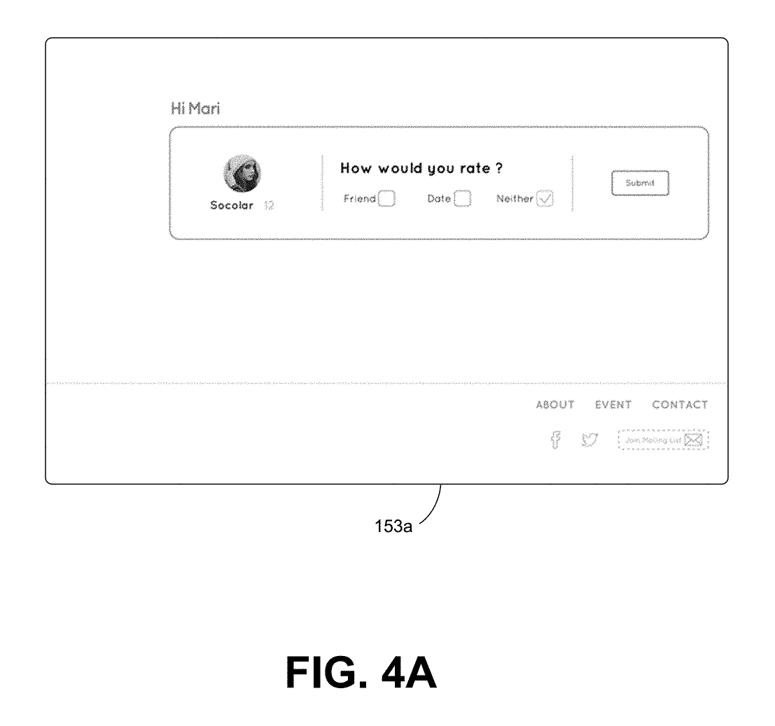

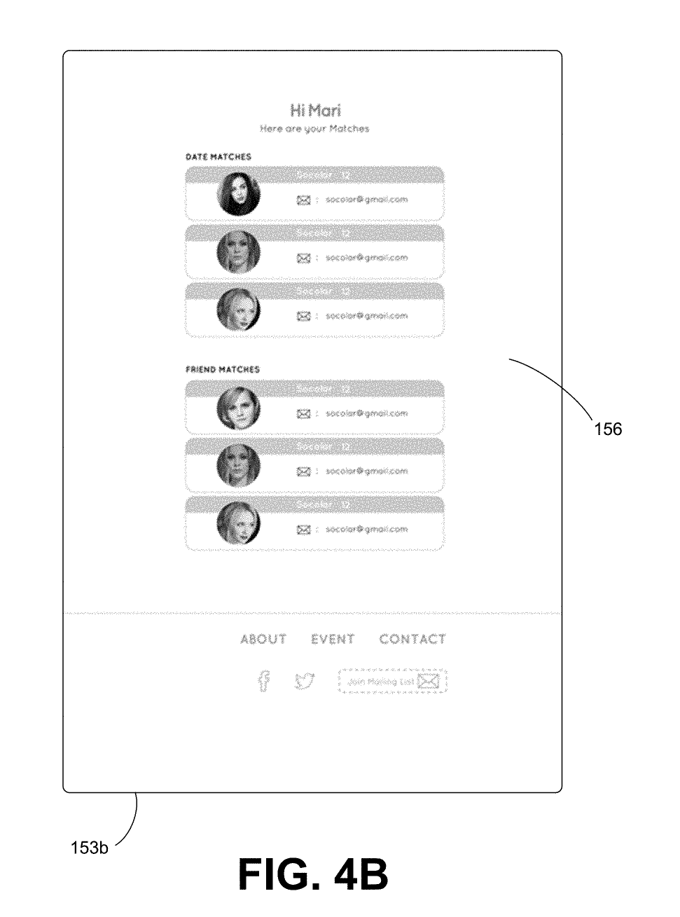

At the end of the event, the feedback notification application 121 can generate a results notification 156 (FIG. 4B) for each participant of the event. In some embodiments, the organizer via the organizer client application 141 dictates the method of notification for the results notification 156. In other embodiments, the feedback notification application 121 automatically generates and transmits the results notification(s) 156.

The results notification 156 may include match data according to the feedback received from each participant client device 109 as inputted by each of the matched participants. The results notification 156 may comprise a text message, an email, a link to access a user interface 153 served up by the feedback notification application 121 that is rendered on the display 139 by the client participant application 150, a third-party social media site, and/or other appropriate notification. The results notification 156 may indicate which participants are considered a match at the end of the event based in part on the level of interest of each of the participants matched for an event round. For example, if participant A and participant B both indicated an interest for one another, they will be considered a match and the results notification 156 will indicate the successful match. However, if one or both of the participants did not indicate an interest for the other party, they may both be notified of the non-match. In some embodiments, participants are not notified of non-matches. In some embodiments, the results notification 156 may include contact information for a matching participant.

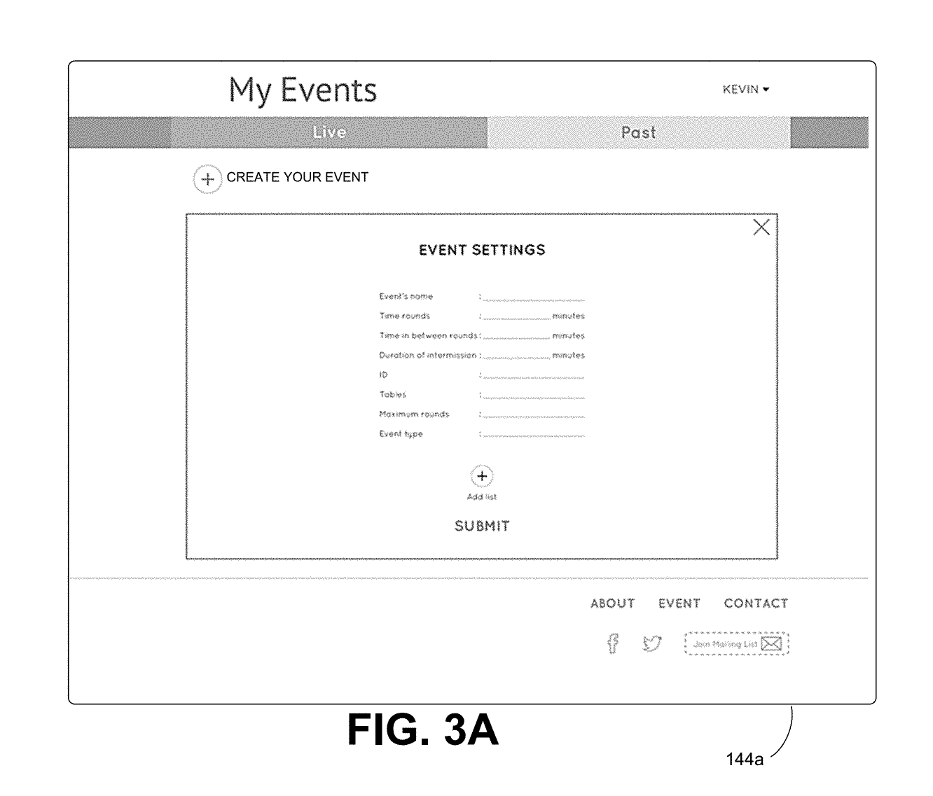

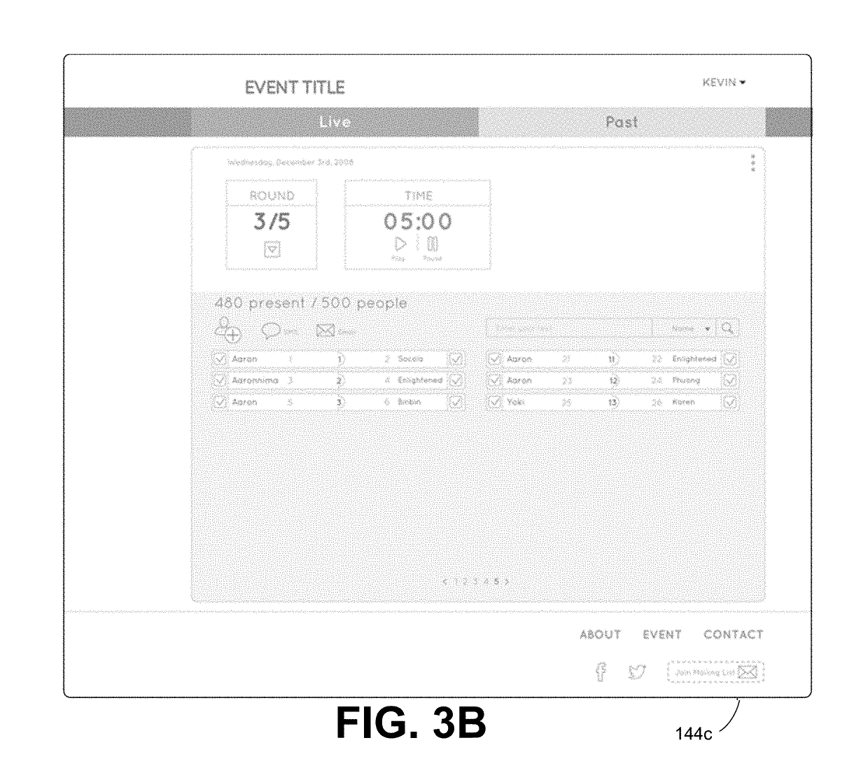

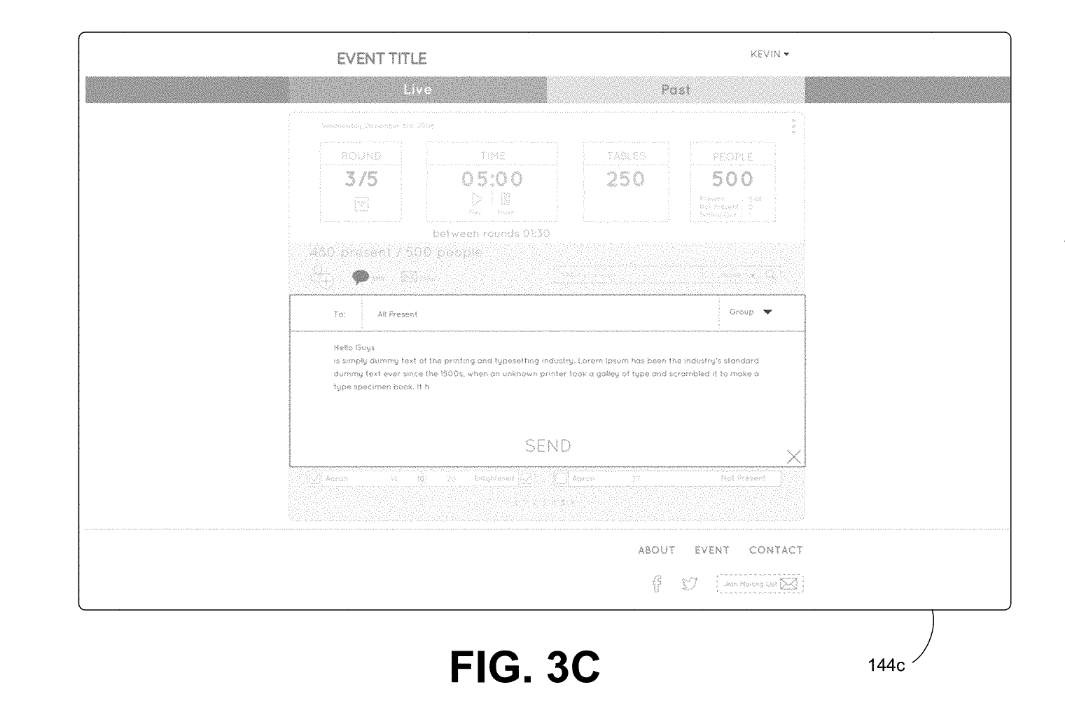

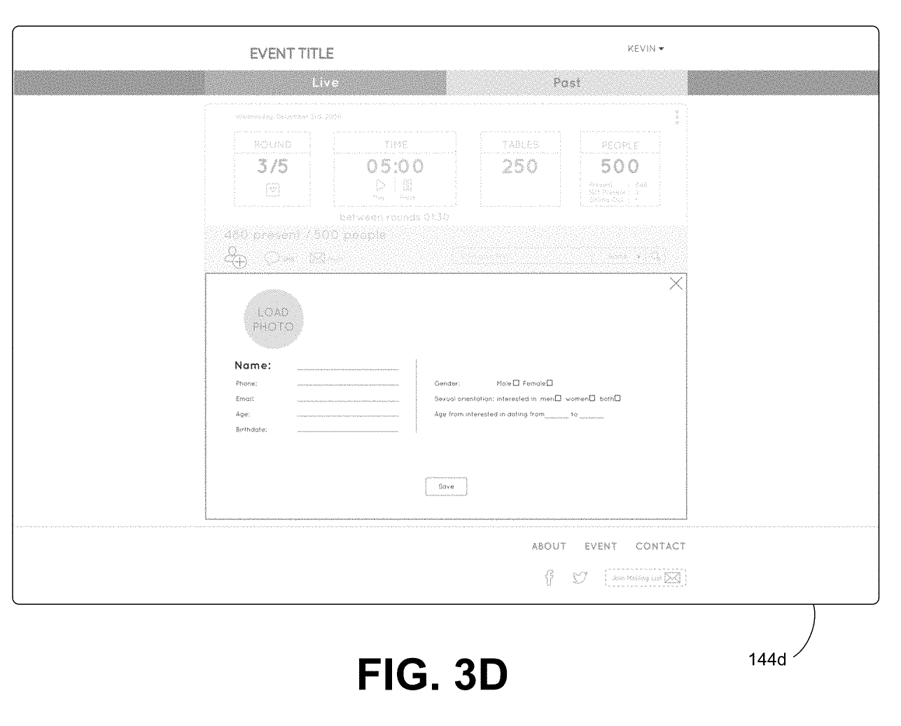

Referring next to FIGS. 3A-3D, shown are example user interfaces of the organizer client application 141 being rendered by the organizer client device 106 according to various embodiments of the present disclosure. FIG. 3A is an example of a user interface 144a of the organizer client application 141 that allows an organizer to provide event data 124 such as, for example, event name, event type, time of each round, time in between rounds, duration of intermission, number of tables, number of rounds, and/or other information.

FIG. 3B is an example of a user interface 144b of the organizer client application 141 that provides information related to each event. As shown in FIG. 3B, the event organizer may control the time associated with each round. For example, the rounds may be automatically started via the participant matching application 118, but the organizer can pause and/or unpause the timer associated with the round as desired. Additionally, via FIG. 3B, the event organizer is able to access the current participant matches for the particular round, mark participants as present or absent, send notifications to one or more participants, search for particular participants, and so on.

FIG. 3C illustrates an example user interface 144c of the organizer client application 141 in which the organizer is capable of creating an organizer notification that can be transmitted to the participants of the event. In some embodiments, the organizer can select how to transmit the organizer notification. For example, in FIG. 3C, the organizer can request to send the message via a text (e.g., short message service (SMS), etc.) or an email. FIG. 3D illustrates an example user interface 144d of the organizer client application 141 that facilitates input of participant profile information. It should be noted that while the interface of FIG. 3D is shown as being rendered via the organizer client application 141, the participant client application 150 can also render a similar user interface. As such, the participant is able to input profile information via a similar user interface 153 rendered by the participant client device 109.

Turning now to FIGS. 4A-4B, shown are example user interfaces that can be rendered by the participant client application 150 according to various embodiments of the present disclosure. For example, FIG. 4A illustrates an example user interface 153a of a feedback form rendered on the participant client device requesting feedback from the participant with respect to another participant. As shown, the participant is able to select whether he or she is interested in the other participant as a friend, a date, or neither. FIG. 4B illustrates an example user interface 153b of a results notification 156 rendered by the participant client device 109 according to various embodiments of the present disclosure. For example, FIG. 4B illustrates an example user interface 153b that provides event results that indicate the date and friend matches for a particular participant. In some embodiments, the results notification 156 may include contact information for the matched participants as shown in FIG. 4B.

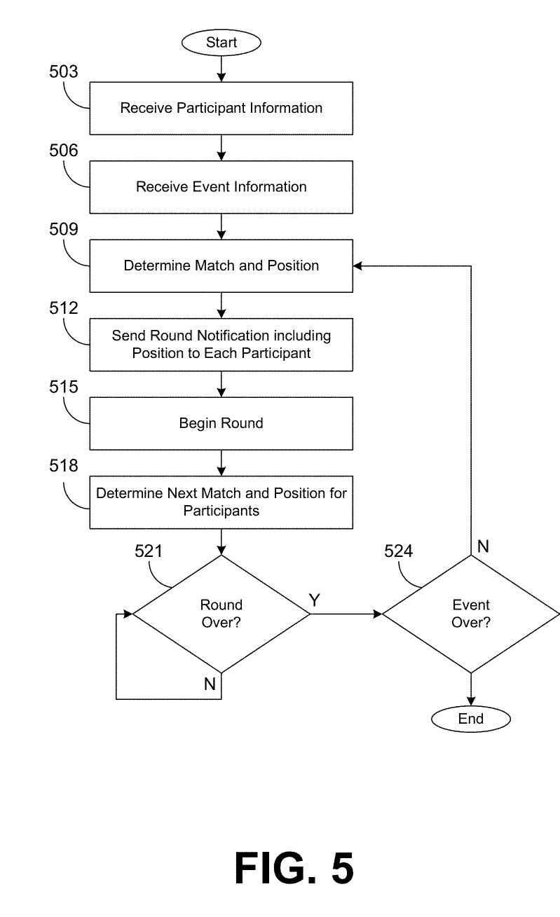

Referring next to FIG. 5, shown is a flowchart that provides one example of the operation of a portion of the participant matching application 118 according to various embodiments. It is understood that the flowchart of FIG. 5 provides merely an example of the many different types of functional arrangements that may be employed to implement the operation of the portion of the participant matching application 118 as described herein. As an alternative, the flowchart of FIG. 5 may be viewed as depicting an example of elements of a method implemented in the computing environment 103 (FIG. 1) according to one or more embodiments.

Beginning with reference numeral 503, the participant matching application 118 receives the participant information. The participant information may comprise information about each participant such as, for example, name, age, gender, sexual orientation, preferred age range for participant matching, occupation, interests, contact information (e.g., phone number, email, address, etc.), social media profile(s), picture(s), and/or other information. The participant matching application 118 may receive the participant information from the participant client device 109 and/or the organizer client device 106. At reference numeral 506, the participant matching application 118 may receive the event information from the organizer client device 106. The event information may comprise event data 124, venue layout data 133, and/or other information. The event data 124 may comprise information about the event such as, for example, name of event, type of event, number of participants, starting time, ending time, number of event rounds, time of each round, time in between each round, number of participants who interact with one another during each round (e.g. pair, group of four, etc.), and/or other information. The venue layout data 133 may comprise information about the event venue such as, for example, number of tables, number of seats per table, proximity of each table to one another, and/or other information.

At reference numeral 509, the participant matching application 118 determines a match and seating position for each of the participants. The participant matching application 118 may match participants according to matching parameters, such as, for example, a number of event tables, a number of participants, participant preferences, participant updates following each round, location of individual participants during each round, and/or other information that can be used to optimize the participant matches and seating locations for each round. In some embodiments, the participant matching application 118 may utilize graph theory libraries to optimize matches based at least in part on profile matches and/or venue layout data 133. In other embodiments, the participant matching application 118 can analyze one or more factors and generate a score based at least in part on a sum of weights assigned to one or more factors to determine a match. In some embodiments, participants having a VIP status may be matched prior to other participants and/or may be given a greater consideration in selecting optimal matches.

At reference numeral 512, the participant matching application 118 generates the event round notifications for each of the participants and transmits the event round notifications to the respective participant client devices 109. In some embodiments, the event round notifications comprise a text (e.g., SMS, etc.), an email, and/or other type of notification. The event round notification informs the participant of his or her match for the round and/or the meeting location (e.g., seat and/or table location). In some embodiments, the event round notification may inform the participant of a specific activity that is to be performed with his or her respective match(es) for the round. For example, the event round notification may state that the participant will be performing a treasure hunt and may provide a clue associated with the treasure hunt.

At reference numeral 515, the participant matching application 118 begins the round. In some embodiments, the participant matching application 118 begins the round and starts keeping track of the time of the round in response to receiving a request to begin the round from the organizer client device 106. In other embodiments, the participant matching application 118 monitors the current time and begins the round when the current time is equal to the event round start time as indicated in the event data 124. For example, if the event is to start at 8:00 pm Eastern Standard Time (EST), the participant matching application 118 may automatically begin the round at that time.

At reference numeral 518, the participant matching application 118 determines the next match and meeting location for the participants for the next round according to the methods discussed at reference numeral 509. At reference numeral 521, the participant matching application 118 may determine if the event round has completed based at least in part on the amount of time that has elapsed. If the event round is not over, the participant matching application 118 remains at reference numeral 521. If the event round has completed, the participant matching application 118 determines if the event is over at reference numeral 524. For example, the participant matching application 118 can determine if the event is over according to the number of completed rounds, an end time of the event, a notification received from the organizer client device 106, and/or other data. If the event is not over, the participant matching application 118 proceeds to reference numeral 509. Otherwise, the participant matching application 118 ends.

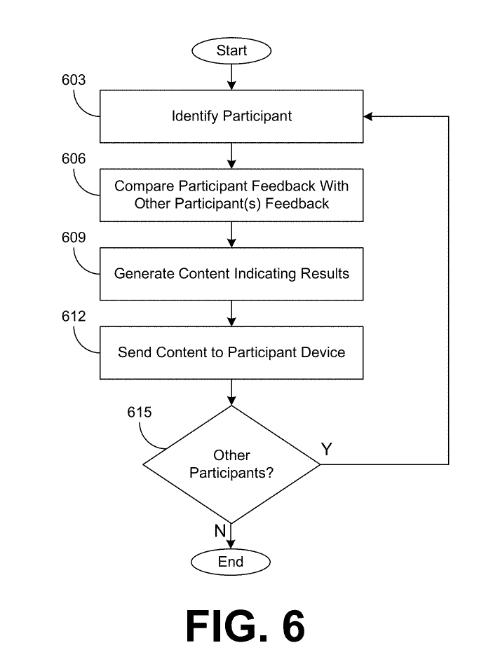

Referring next to FIG. 6, shown is a flowchart that provides one example of the operation of a portion of the feedback notification application 121 according to various embodiments. It is understood that the flowchart of FIG. 6 provides merely an example of the many different types of functional arrangements that may be employed to implement the operation of the portion of the feedback notification application 121 as described herein. As an alternative, the flowchart of FIG. 6 may be viewed as depicting an example of elements of a method implemented in the computing environment 103 (FIG. 1) according to one or more embodiments.

Specifically, FIG. 6 relates to a portion of the feedback notification application 121 that generates results data that is transmitted to the participants to notify the participants of any matches from the event. The feedback notification application 121 may generate the results data in response to receiving an instruction from the organizer client device 106. In other embodiments, the feedback notification application 121 may generate the results data automatically upon detection of the end of the event. In other embodiments, the feedback notification application 121 may generate the results data upon receipt of a predefined number and/or percentage of feedback received from the participant client devices 109.

Beginning with reference numeral 603, the feedback notification application 121 identifies a participant of the event. For example, the feedback notification application 121 may access the participant data 127 stored in the data store to identify the participant. By identifying the participant, the feedback notification application 121 can also determine the other participants that were matched with the particular participant during the event. In some embodiments, a participant may provide identifying information about another participant that the participant wants to provide feedback on even though the participant was not matched with the other participant. For example, if the participant meets the other participant during, for example, a restroom break, the food table, the drink table, registration, etc., the participant may still provide input (e.g., rating, like/dislike, etc.) and identifying information. In another non-limiting example, a participant can identify another participant by reviewing and selecting pictures and/or profile information displayed on a user interface of the client participant application. The identifying information may comprise an assigned number, a name, a picture, and/or other type of information that may be used to identify the other participant.

At reference numeral 606, the feedback notification application 121 compares feedback received from the participant client device 109 of the particular participant with the feedback received from the participant client devices 109 of the other participants who were matched with the particular participant. As such, the feedback notification application 121 can determine which of the other participants, if any, are considered a date match, friend match, business match, and/or other type of match based in part on the results.

At reference numeral 609, the feedback notification application 121 generates content indicating the results for a particular participant. In one non-limiting example, the feedback notification application 121 may generate a user interface similar to that of FIG. 4B, which indicates the date and/or friend matches from the event. At reference numeral 612, the feedback notification application 121 sends the content to the participant device. For example, the feedback notification application 121 may transmit the user interface to the participant client device 109. In another non-limiting example, the content may comprise a text message and/or an email message, and the feedback notification application 121 may send the participant client device 109 the text message and/or the email message notifying the participant of the match results according to the feedback received from the participant client devices 109.

In reference numeral 615, the feedback notification application 121 determines whether there are other participants of the event. If there are other participants of the event, the feedback notification application 121 proceeds to reference numeral 603 to identify another participant. Otherwise, the feedback notification application 121 ends.

With reference to FIG. 7, shown is a schematic block diagram of the computing environment 103 according to an embodiment of the present disclosure. The computing environment 103 includes one or more computing devices 703. Each computing device 703 includes at least one processor circuit, for example, having a processor 709 and a memory 706, both of which are coupled to a local interface 712. To this end, each computing device 703 may comprise, for example, at least one server computer or like device. The local interface 712 may comprise, for example, a data bus with an accompanying address/control bus or other bus structure as can be appreciated.

Stored in the memory 706 are both data and several components that are executable by the processor 709. In particular, stored in the memory 706 and executable by the processor 709 are the participant matching application 118, the feedback notification application 121, and potentially other applications. Also stored in the memory 706 may be a data store 115 and other data. In addition, an operating system may be stored in the memory 706 and executable by the processor 709.

It is understood that there may be other applications that are stored in the memory 706 and are executable by the processor 709 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 706 and are executable by the processor 709. In this respect, the term “executable” means a program file that is in a form that can ultimately be run by the processor 709. Examples of executable programs may be, for example, a compiled program that can be translated into machine code in a format that can be loaded into a random access portion of the memory 706 and run by the processor 709, source code that may be expressed in proper format such as object code that is capable of being loaded into a random access portion of the memory 706 and executed by the processor 709, or source code that may be interpreted by another executable program to generate instructions in a random access portion of the memory 706 to be executed by the processor 709, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 709 may represent multiple processors 709 and/or multiple processor cores and the memory 706 may represent multiple memories 706 that operate in parallel processing circuits, respectively. In such a case, the local interface 712 may be an appropriate network that facilitates communication between any two of the multiple processors 709, between any processor 709 and any of the memories 706, or between any two of the memories 706, etc. The local interface 712 may comprise additional systems designed to coordinate this communication, including, for example, performing load balancing. The processor 709 may be of electrical or of some other available construction.

Although the participant matching application 118, the feedback notification application 121, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 5 and 6 show the functionality and operation of an implementation of portions of the participant matching application 118 and feedback notification application 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 709 in a computer system or other system. The machine code may be converted from the source code, etc. If embodied in hardware, each block may represent a circuit or a number of interconnected circuits to implement the specified logical function(s).

Although the flowcharts of FIGS. 5 and 6 show a specific order of execution, it is understood that the order of execution may differ from that which is depicted. For example, the order of execution of two or more blocks may be scrambled relative to the order shown. Also, two or more blocks shown in succession in FIGS. 5 and 6 may be executed concurrently or with partial concurrence. Further, in some embodiments, one or more of the blocks shown in FIGS. 5 and 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the participant matching application 118 and the feedback notification application 121, that comprises software or code can be embodied in any non-transitory computer-readable medium for use by or in connection with an instruction execution system such as, for example, a processor 709 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the participant matching application 118 and the feedback notification application 121, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 703, or in multiple computing devices in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device; and
at least one application executable by the at least one computing device, wherein, when executed, the at least one application causes the at least one computing device to at least:
receive event information from an organizer client device, the event information including one or more parameters associated with an in-person social interaction event;
identify a plurality of participants present at the in-person social interaction event;
determine a plurality of event round matches for the plurality of participants for an event round, individual event round matches matching a respective participant with one or more respective other participants based at least in part on participant data and the event information;
notify individual participants of the plurality of participants of a respective event round match and a seating location for the event round;
receive feedback from the individual participants in response to requesting the feedback, the feedback indicating a level of interest that the respective participant has for at least one of the one or more respective other participants or one or more non-matched participants at the in-person social interaction event;
analyze the feedback; and
transmit a notification to the individual participants, the notification including the level of interest.

2. The system of claim 1, wherein the notification comprises at least one of a text message, an application notification, or an email message.

3. The system of claim 1, wherein the one or more parameters comprise at least one of a number of event rounds, an event duration time, a round duration time, a start time, an end time, a number of tables, a venue layout, a notification type, or an amount of time between each event round.

4. The system of claim 1, wherein the at least one application further causes the at least one computing device to at least receive the participant data from a participant client device.

5. The system of claim 1, wherein the participant data comprises participant preference data which includes at least one of an age range, a gender, an interest, or an occupation.

6. The system of claim 1, wherein notifying the individual participants of the respective event round match and the seating location for the event round further comprises transmitting a text message to a respective participant client device, the text message including the seating location and at least one of: (1) a name of the one or more respective other participants or (2) a clue about the one or more respective other participants.

7. The system of claim 1, wherein notifying the individual participants of the respective event round match and the seating location for the event round further comprises transmitting an email message to a respective participant client device, the email message including the seating location and at least one of: (1) a name of the one or more respective other participants or (2) a clue about the one or more respective other participants.

8. The system of claim 1, wherein notifying the individual participants of the respective event round match and the seating location for the event round further comprises transmitting an application notification to a respective participant client device, the application notification including the seating location and at least one of a name of the one or more respective other participants or a clue about the one or more respective other participants.

9. The system of claim 1, wherein the in-person social interaction event comprises a plurality of event rounds and the at least one application causes the at least one computing device to at least determine a new plurality of event round matches during each event round of the plurality of event rounds, the new plurality of event round matches matching the respective participant with a participant who is different from a prior event round match.

10. The system of claim 1, wherein the in-person social interaction event comprises a plurality of event rounds and the at least one application causes the at least one computing device to at least determine a new plurality of event round matches during each event round of the plurality of event rounds, at least one of the new plurality of event round matches matching the respective participant with a participant who is the same from a prior event round match.

11. The system of claim 1, wherein the plurality of event round matches are determined via graph theory libraries.

12. The system of claim 1, wherein the plurality of event round matches are further based at least in part on at least one of a very important person (VIP) status of the respective participant, a current seating location of the respective participant, or a number of participants.

13. A method, comprising:
determining, via at least one computing device, a first plurality of event round matches for a plurality of participants participating in a first event round of an in-person interaction event based at least in part on one or more event parameters received from an organizer client, individual event round matches matching a respective participant with one or more first participants of the plurality of participants;
generating, via at least one computing device, a plurality of meet-up notifications for the plurality of participants, individual meet-up notifications of the plurality of meet-up notifications including a meet-up location for the event round match of the respective participant at the in-person interaction event;
sending, via the at least one computing device, the plurality of meet-up notifications to the plurality of participants;
determining, via the at least one computing device, a second plurality of event round matches for a second event round during an occurrence of the first event round, individual event round matches the respective participant with one or more second participants of the plurality of participants; and
sending, via the at least one computing device, the second plurality of event round matches to the plurality of participants.

14. The method of claim 13, further comprising receiving, via the at least one computing device, feedback from individual participants, the feedback indicating a level of interest that the respective participant has for at least one of the plurality of participants.

15. The method of claim 14, further comprising:
analyzing, via the at least one computing device, the feedback received from the individual participants; and
determining, via the at least one computing device, the level of interest based at least in part on the feedback.

16. The method of claim 15, further comprising:
generating, via the at least one computing device, a respective feedback notification for the individual participants, the respective feedback notification including the level of interest between the respective participant and the at least one of the plurality of participants; and
transmitting, via the at least one computing device, the respective feedback notification to the respective participant client device of the individual participants.

17. The method of claim 13, wherein at least one of the one or more second participants is different from the one or more first participants.

18. A system, comprising:
at least one computing device;
an organizer client device in data communication with the at least one computing device;
a plurality of participant client devices in data communication with the at least one computing device; and
at least one application executable by the at least one computing device, wherein, when executed, the at least one application causes the at least one computing device to at least:
determine a plurality of event round groups between a plurality of participants for a first event round of an in-person interaction event according to one or more event parameters received from the organizer client device, individual event round groups grouping individual participants with one or more other participants;
generate a plurality of notifications notifying the plurality of participants of a meeting location for the first event round and identification associated with the one or more other participants;
transmit individual notifications to individual participant client devices associated with individual participants;
receive feedback from at least a portion of the participant client devices; and
send a respective notification to individual participant client devices, the respective notification including a level of interest between a respective participant and at least one other participant.

19. The system of claim 18, wherein the one or more event parameters comprise at least one of a number of event rounds, an event duration time, a round duration time, a start time, an end time, a number of tables, a venue layout, a notification type, or an amount of time between each event round.

20. The system of claim 18, wherein the at least one application further causes the at least one computing device to at least determine a new plurality of event round matches for a second event round of the in-person interaction event based at least in part on the feedback.
